(19) United States
(12) Patent Application Publication
(10) Pub. No.: US 2007/0057974 A1
(43) Pub. Date: Mar. 15, 2007

(54) Scroll button assembly for video game controller

(76) Inventor: Mark W. Woodson, Palmetto, FL (US)

Correspondence Address: PETER J. VAN BERGEN, 402 WEST DUKE OF GLOUCESTER STREET, WILLIAMSBURG, VA, 23185, US

(21) Appl. No.: 11/517,063

(22) Filed: Sep. 7, 2006

Related U.S. Application Data
(60) Provisional application No. 60/715,844, filed on Sep. 9, 2005.

(51) Int. Cl. G09G 5/00

(52) U.S. Cl. 345/684

(57) ABSTRACT

A system for receiving user inputs for a hand-held video game controller is provided. At least one scroll button assembly is coupled to the hand-held video game controller. Each scroll button assembly controls the scrolling through of options presented by a video game. The scroll button can also be configured to control the selection of one of the “scrolled to” options.

### ORIGIN OF THE INVENTION

Pursuant to 35 U.S.C. §119, the benefit of priority from provisional application 60/715,844, with a filing date of Sep. 9, 2005, is claimed for this non-provisional application.

### FIELD OF THE INVENTION

The invention relates generally to video game controllers, and more particularly to a rotatable scroll button assembly that can be used in a video game controller.

### BACKGROUND OF THE INVENTION

Video game controllers for the most popular brands of game players (i.e., PS2™, GAME CUBE™ and X-BOX™) are fairly similar in design as is well-known in the art. Briefly, these game controllers have left and right grip “wings” coupled to either side of a console region. The player grips the left and right wings with his left and right hands, respectively, such that the player's left and right thumbs are positioned above the various analog and push button controls on the console region. As a result, the remainder of the player's fingers are essentially underneath the console region.

Typically, the operation of choosing one of a plurality of gaming options is accomplished by (i) scrolling through the various options using one of the controller's input devices (e.g., by movement of the controller's analog stick, successive pressing of one of the controller's buttons such as the “down arrow”, etc.), and then (ii) selecting a “highlighted” option using another of the controller's input devices that is different than the one used for scrolling. In today's fast-moving game environments, this is inefficient as the player must use two different input devices to generate a gaming option selection. Furthermore, this type of operation can lead to player confusion that negatively impacts game performance as a player is forced to use the same input devices for game tasks and game option selection.

### SUMMARY OF THE INVENTION

Accordingly, it is an object of the present invention to provide a video game player with the ability to scroll through and select game options with a single input device on a video game controller.

Another object of the present invention to provide a video game player with the ability to scroll through and select game options with a game controller input device that can be dedicated to such operations.

Still another object of the present invention to provide a video game controller player with the ability to scroll through and select game options using a game controller input device that can be oriented in accordance with a player's preference and hand/finger comfort.

Yet another object of the present invention to provide a video game the player with the ability to scroll through and select game options using a controller input device that can be operated by one of the player's little or never used fingers.

Other objects and advantages of the present invention will become more obvious hereinafter in the specification and drawings.

In accordance with an embodiment of the present invention, a system for receiving user inputs for a hand-held video game controller is provided. At least one scroll button assembly is coupled to the hand-held video game controller. Each scroll button assembly includes a housing and a mounting assembly supported by the housing such that the mounting assembly can be rotated about an axis thereof in a first plane of rotation. The assembly further includes a scrolling wheel coupled to the mounting assembly such that the scrolling wheel can be rotated about an axis thereof in a second plane of rotation that is substantially perpendicular to the first plane of rotation. A first assembly coupled to the scrolling wheel detects a rotational position thereof in the second plane of rotation for any orientation of the mounting assembly in the first plane of rotation. A second assembly coupled to the housing detects movement thereof in a direction substantially perpendicular to the first plane of rotation. Rotation of the scrolling wheel in the second plane of rotation controls the scrolling through of options presented by a video game. Movement of the housing in a direction substantially perpendicular to the first plane of rotation is used to control the selection of one of the “scrolled to” options.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a plan view of the underside of a conventional “two-handed” video game controller provided with scroll buttons in accordance with an embodiment of the present invention;

FIG. 2 is an isolated plan view of a scroll button and mounting assembly in accordance with an embodiment of the present invention;

FIG. 3 is a cross-sectional view taken along line 3-3 in FIG. 2 further illustrating in isolation the scroll button's mounting assembly that provides for orientation adjustment in accordance with the present invention;

FIG. 4A is an isolated perspective view of a portion of an optical assembly that can be used in conjunction with the scroll button to detect the scroll button's position;

FIG. 4B is a top view of the optical assembly taken along line 4-4 in FIG. 4A;

FIG. 5 is an isolated head-on view of a sub-assembly that includes the scroll button and optical assembly of FIG. 4;

FIG. 6 is an isolated plan view of the spoke wheel used in the FIG. 4 sub-assembly; and

FIG. 7 is a side view of a complete scroll button assembly in accordance with an embodiment of the present invention.

### DETAILED DESCRIPTION OF THE INVENTION

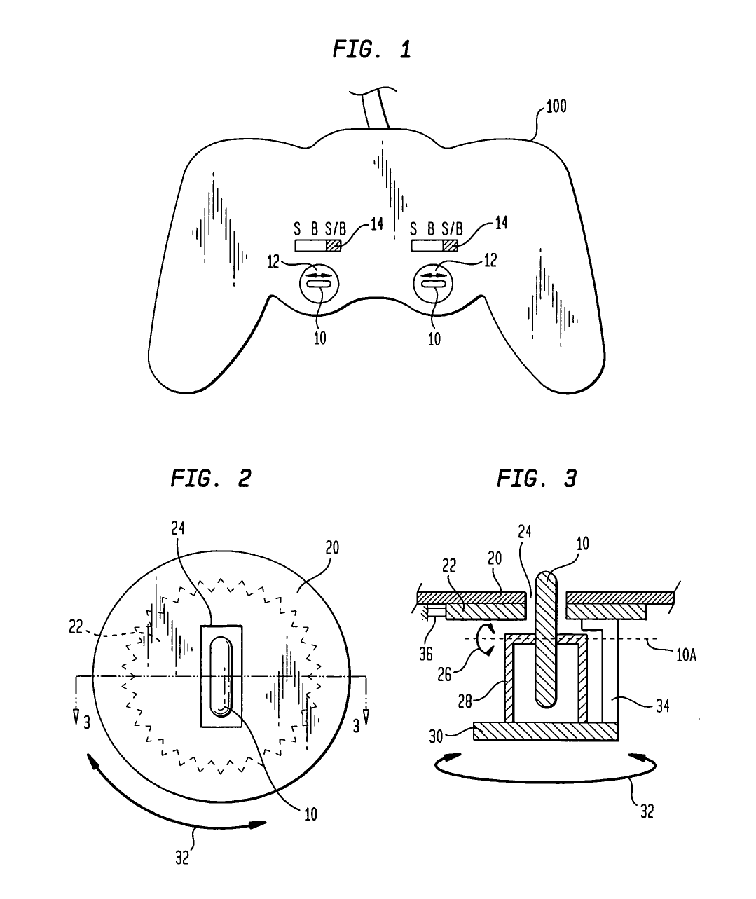

Referring now to the drawings, and more particularly to FIG. 1, the underside of a video game controller 100 is shown. Video game controller 100 can be any of the conventional “two-handed” game controllers well known in the art of video gaming. Accordingly, the term “underside” as used herein refers to the portion of video game controller 100 that is generally readily accessible by one or more of a user's index, middle, ring and pinky fingers. More specifically, when the user grips controller 100, the controller's other conventional controls (e.g., analog sticks, trackballs, buttons, etc.) are in view of the user and accessible by the user's thumbs. The remaining four fingers of each of the user's hands will have access to the underside of controller 100 shown in FIG. 1. It is to be understood that the choice of controller 100 is not a limitation of the present invention.

Positioned on the underside of controller 100 are one or two (as shown) scroll wheels/buttons 10 (hereinafter referred to simply as “scroll buttons”). Scroll buttons 10 are located such that they are in position for access by one or more of a player's index, middle, ring or pinky fingers when controller 100 is gripped in the conventional fashion. Typically, this means that scroll buttons 10 are placed underneath and opposing the controller's analog sticks, trackballs, etc. (not shown) which are on the top side of controller 100. In the illustrated embodiment where two scroll buttons 10 are used, one of scroll buttons 10 will generally be accessible to the user's right hand fingers while the other of scroll buttons 10 will generally be accessible to the user's left hand fingers.

In accordance with the present invention, scroll buttons 10 can be rotated in either direction (indicated by two-headed arrow 12) and configured such that this rotation causes a video game to scroll through options (e.g., on a menu, on a screen overlay, etc.) presented to a player during a gaming situation. Once the particular selection is “highlighted” on the gaming screen (not shown), scroll button 10 can be depressed as a push button (e.g., into the page in terms of the figure) to select the highlighted option. In general, such depressible scroll buttons and their designs are well known in the art.

Although not a requirement of the present invention, each of scroll buttons 10 can have a function selector switch 14 associated therewith that is coupled to the game controller's electronics (not shown). Switch 14 can be, for example, a three-position switch that governs the functions of it's associated scroll button 10 as follows:

(i) position “S” limits the use of scroll button 10 to the scrolling function thereof;

(ii) position “B” limits the use of scroll button 10 to the push button function thereof; and

(iii) position “S/B” allows scroll button 10 to provide both the scrolling and push button functions.

Note that a four-position switch could also be used where the fourth position is used to turn off all functions of scroll button 10.

As shown in FIG. 1, each of scroll buttons 10 is oriented such that its plane of rotation is aligned in the width direction of controller 100. However, this may or may not suit the hand/finger size or positioning comfort of the particular player. Further, the way that controller 100 is actually gripped can vary greatly from player-to-player. Accordingly, the present invention can also provide the means to change the orientation of scroll buttons 10 to suit a particular user's comfort and/or preference.

Referring now simultaneously to FIGS. 2 and 3, a simple mechanical embodiment of a rotatable mounting assembly that provides for the reorientation of scroll button 10 in accordance with the present invention is illustrated. A rotor 20 having an attached spline gear 22 is disposed about scroll button 10. More specifically, a portion of button 10 protrudes through a hole 24 formed in rotor 20 and spline gear 22 for access by a player. Scroll button 10 is mounted for rotation (as indicated by two-headed arrow 26) about it's central axis 10A by a scroll button mount 28 and a platform 30 capable of rotation in either direction as indicated by two-headed arrow 32. A coupling support 34 mechanically links rotor 20/spline gear 22 to rotatable platform 30 such that rotation of rotor 20 in either direction 32 results in corresponding rotation of platform 30. Rotation of platform 30 in either direction 32 occurs in a plane of rotation that is parallel to rotor 20 and spline gear 22. This plane of rotation of platform 30/rotor 20/spline gear 22 is perpendicular to the plane of rotation (defined by two-headed arrow 26) of scroll button 10 about axis 10A.

Rotor 20 is held in a selected rotational orientation by, for example, a fixed leaf spring 36 that cooperates with two gear teeth of spline gear 22. However, if a player wants to change the orientation of scroll button 10, a rotation force (sufficient to overcome the holding force applied by leaf spring 36) is applied to rotor 20 in either rotation direction 32. In turn, the rotation force causes the simultaneous rotation of rotor 20, spline gear 22 and platform 30 (on which scroll button 10 is mounted). Once the rotation force is removed, the engagement of leaf spring 36 with spline gear 22 retains the new orientation of scroll button 10. Rotor 20, spline gear 22 and platform 30 can be configured for a full 360° of rotation or something less than 360° without departing from the scope of the present invention.

Regardless of the orientation of scroll button 10 defined by the rotation thereof in either direction 32, scroll button 10 must be able to provide scrolling, push button, or scrolling and push button functions. Accordingly, a mechanism for providing and detecting these functions must be able to operate regardless of the orientation of scroll button 10. With respect to the scrolling function, an optical system can be used to “read” the position of the scroll button. While such optical reading of the rotational position of a scroll button is well known in the art, the present invention's optical system will work for any orientation of the scroll button.

Referring now simultaneously to FIGS. 4A and 4B, a portion 50 of the optical assembly that allows for a reading of the scroll button in any orientation is illustrated in isolation. Assembly 50 is configured to rotate in unison about a central axis of rotation 50A. Assembly 50 includes three optically distinct components that are optically isolated from one another while being mechanically coupled to one another to form a single mechanical unit. Each of the optical components can be made from an optically transmissive material (e.g., plastic) coated with reflective paint to enhance light transmissivity while protecting against the intrusion of outside light. For clarity of illustration, only the optical components are shown as the mechanical coupling of the optical components into a single mechanical unit can be accomplished in a variety of ways without departing from the scope of the present invention.

The first optical component of assembly 50 is an outer ring 52 having a light conduit 54 optically coupled thereto and extending therefrom in a perpendicular fashion as illustrated. The second optical component is a separate inner ring 56 having a light conduit 58 optically coupled thereto and extending therefrom in a perpendicular fashion as illustrated. Light conduits 54 and 58 are substantially parallel to one another and are separated by a small gap 62. The third optical component is a light conduit 60 that extends from within inner ring 56 and partially along axis 50A before being shaped to be adjacent to the outboard portion of light conduit 58 and parallel thereto. The outboard portion of light conduit 60 is substantially parallel to light conduit 54 and is spaced apart therefrom by small gap 62. Light conduit 54 terminates in a transmissive window 54A that opposes transmissive windows 58A and 60A in conduits 58 and 60, respectively, across small gap 62. A stationary light source 64 is positioned for optical coupling to outer ring 52. Stationary light sensors 66 and 68 are positioned for optical coupling to inner ring 56 and light conduit 60, respectively.

From an optical perspective, assembly 50 will function the same regardless of the rotational orientation thereof relative to central axis 50A. That is, in general, light from source 64 is coupled to outer ring 52 and then to light conduit 54 where the light is conducted to and exits window 54A. If the exiting light is unobstructed as it crosses gap 62, the light enters conduits 58 and 60 via windows 58A and 60A, respectively. Light entering conduit 58 passes through to inner ring 56 for detection by light sensor 66. Light entering conduit 60 passes therethrough for detection by light sensor 68. Control of light source 64 and the reading of light sensors 66 and 68 is governed by an optical control system 69 coupled thereto in ways that would be well understood in the art. Optical control system 69 provides the sensed signals to a video game 200 for game processing.

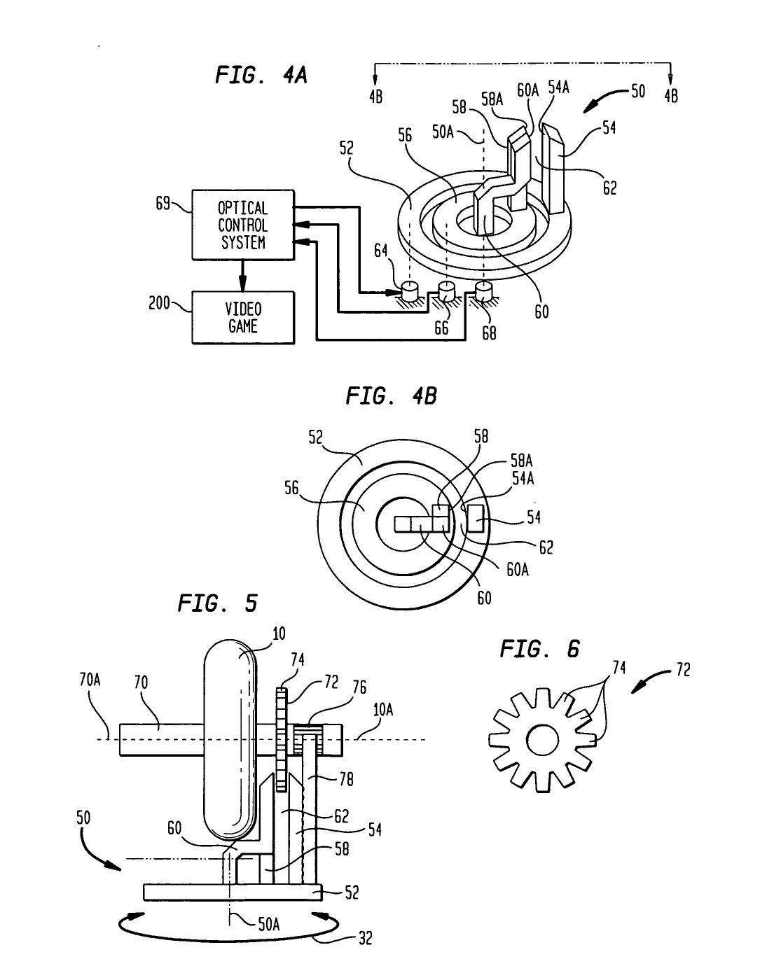

Referring now to FIG. 5, assembly 50 is mechanically coupled to scroll button 10 such that it functions as the mechanical equivalent of platform 30 (FIG. 3). Scroll button 10 is mounted on an axle 70 for rotation about it's central axis 70A that is coincident with axis 10A of scroll button 10. Coupled to axle 70 is a spoke wheel 72 (shown in an isolated plan view in FIG. 6) having radially-extending and spaced-apart spokes 74 that are positioned in gap 62 defined by optical assembly 50. Axle 70 has a spline region 76 that cooperates with a leaf spring 78 supported by, for example, outer ring 52 for rotation therewith about axis 50A. Leaf spring 78 keeps scroll button 10 in a particular position until a player applies a rotation force to scroll button 10 such that it rotates about axis 70A.

When using scroll button 10 for scrolling, rotation of button 10 about axis 70A brings about a corresponding rotation of spoke wheel 72. Spokes 74 are sized/spaced such that as spokes 74 pass through gap 62, light across gap 62 is intermittently blocked from entering one of light conduits 58 and 60. This enables electronics (not shown) coupled to sensors 66 and 68 to tell how many “steps” a player has spun scroll button 10 as well as the rotational direction of scroll button 10. Such optical position and direction reading of a spoke wheel is well understood in the art.

As will be explained further below, the present invention provides for the simultaneous rotation of assembly 50/scroll button 10/axle 70 in either direction 32 about axis 50A. In this way, the above-described optical cooperation between spoke wheel 72 and optical assembly 50 remains identical regardless of the rotational orientation of optical assembly 50 about axis 50A.

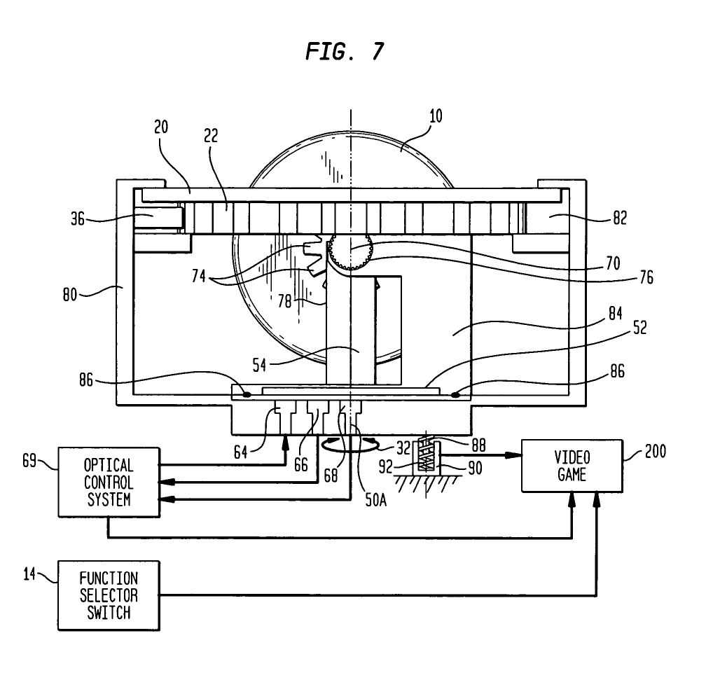

By way of illustrative example, a complete scroll button assembly in accordance with an embodiment of the present invention is illustrated in FIG. 7. A housing 80 defines an annular channel 82 capable of rotational support of rotor 20 and spline gear 22. A mount 84, coupled to spline gear 22 and axle 70 while supporting assembly 50, rests on bearings 86 provided in the bottom of housing 80 to facilitate the rotation of mount 84 about axis 50A. In this way, as a player rotates rotor 20 about axis 50A in either direction 32, mount 84 will re-orient scroll button 10 to a desired orientation. Once a desired orientation is achieved, leaf spring 36 (which is coupled to housing 80 and continuously engages spline gear 22) maintains the desired orientation. Light source 64 and sensors 66/68 are mounted in a stationary fashion to housing 80 and function as previously described to “read” the rotational position of scroll button 10.

As mentioned above, it may be desirable to give the user the ability to select a “scrolled to” or highlighted option using the same input device. Accordingly, the scroll button assembly of the present invention can also be configured such that scroll button 10 can be depressed to select a “scrolled to” or highlighted option in a video game. In the illustrated embodiment, depression of scroll button 10 in a direction substantially aligned with axis 50A (i.e., perpendicular to the plane of rotation defined by rotation about axis 50A in either direction 32) is transferred to axle 70/mount 84 and into housing 80. Accordingly, the present invention can be configured to detect the depression of scroll button 10 by allowing housing 80 to “float” within the video game controller and then use a detector (e.g., an electromechanical detector) to sense movement of housing 80 caused by depression of scroll button 10. For example, housing 80 can incorporate a pin 88 that actuates a contact switch 90 (e.g., fixedly mounted in the controller body which is not shown for clarity of illustration) when scroll button 10/housing 80 is depressed. In this case, housing 80 can be spring-mounted in a receptacle (not shown) provided in the controller body or can have a spring 92 disposed between switch 90 and housing 80 as shown such that housing 80/pin 88 is biased away from contact switch 90. In this way, when scroll button 10 is depressed, the force of depression is translated to housing 80 which causes pin 88 to move into contact with switch 90 to activate same. Activation of switch 90 is transmitted to video game 200 for game processing.

The previously described function selector switch 14 (FIG. 1) can be configured to have its output coupled directly to video game 200. The output of switch 14 identifies which signals should be recognized by video game 200 (e.g., signals detected by optical control system 69, signals generated by switch 90, signals from both system 69 and switch 90, or none of the signals from system 69 and switch 90). Thus, function selector switch 14 allows a user to customize the relevance of the scroll button assembly for a particular gaming situation.

The advantages of the present invention are numerous. The scroll button of the present invention will enhance the capability of video game controllers. A player will now be able to use a previously dormant finger to scroll through and, optionally, select a video game option. Since both scrolling and option selection can be accomplished with a single control, the game playing experience is enhanced as less time will be required to scroll through and select game options. In addition, the present invention can be configured to allow a user to re-orient the scroll button to suit a particular user's hand size and choice of finger for operation thereof.

Although the invention has been described relative to a specific embodiment thereof, there are numerous variations and modifications that will be readily apparent to those skilled in the art in light of the above teachings. For example, one, two or more of the scroll button assemblies of the present invention can be included on a video game controller. Further, the scroll button assembly is not limited to placement on the underside of a video game controller and is not even limited to use in video game controllers. That is, the present invention could be incorporated into any game, computer or other computerized input device that can or does make use of scroll buttons. It is therefore to be understood that the invention may be practiced other than as specifically described.

What is claimed as new and desired to be secured by Letters Patent of the United States is:

1. In a hand-held video game controller, a system for receiving user inputs comprising:
at least one scroll button assembly adapted to be coupled to a hand-held video game controller, each said scroll button assembly including
a housing,
a mounting assembly supported by said housing such that said mounting assembly can be rotated about an axis thereof in a first plane of rotation,
a scrolling wheel coupled to said mounting assembly such that said scrolling wheel can be rotated about an axis thereof in a second plane of rotation that is substantially perpendicular to said first plane of rotation,
first means coupled to said scrolling wheel for detecting a rotational position thereof in said second plane of rotation for any orientation of said mounting assembly in said first plane of rotation, and
second means coupled to said housing for detecting movement thereof in a direction substantially perpendicular to said first plane of rotation,
wherein rotation of said scrolling wheel in said second plane of rotation is adapted for use in scrolling through options presented by a video game and wherein said movement of said housing in a direction substantially perpendicular to said first plane of rotation is adapted for use in selecting one of the options.

2. A system as in claim 1 said first means comprises an optical assembly.

3. A system as in claim 1 wherein said second means comprises an electromechanical assembly.

4. A system as in claim 1 further comprising detent means coupled to said housing and said mounting assembly for maintaining an orientation of said mounting assembly in said first plane of rotation.

5. A system as in claim 1 wherein said at least one scroll button assembly comprises first and second scroll button assemblies adapted to be coupled to a portion of the video game controller accessible by at least one of a user's index, middle, ring and pinky fingers.

6. A system as in claim 1 wherein said first means generates a first signal indicative of said rotational position and said second means generates a second signal indicative of said movement, said system further comprising switch means for generating a selection signal indicative of a user-defined relevance of said first signal and said second signal.

7. In a hand-held video game controller, a system for receiving user inputs comprising:
at least one scroll button assembly adapted to be coupled to a region of a hand-held video game controller that is accessible to at least one of a user's index, middle, ring and pinky fingers when the hand-held video game controller is gripped by the user for a gaming operation, each said scroll button assembly including
a housing,
a mounting assembly supported by said housing such that said mounting assembly can be rotated about an axis thereof in a first plane of rotation,
a scrolling wheel coupled to said mounting assembly such that said scrolling wheel can be rotated about an axis thereof in a second plane of rotation that is substantially perpendicular to said first plane of rotation,
first means coupled to said scrolling wheel for detecting a rotational position thereof in said second plane of rotation for any orientation of said mounting assembly in said first plane of rotation, and
second means coupled to said housing for detecting movement thereof in a direction substantially perpendicular to said first plane of rotation,
wherein rotation of said scrolling wheel in said second plane of rotation is adapted for use in scrolling through options presented by a video game and wherein said movement of said housing in a direction substantially perpendicular to said first plane of rotation is adapted for use in selecting one of the options.

8. A system as in claim 7 said first means comprises an optical assembly mounted on said mounting assembly for rotation in said first plane of rotation.

9. A system as in claim 7 wherein said second means comprises an electromechanical assembly.

10. A system as in claim 7 further comprising detent means coupled to said housing and said mounting assembly for maintaining an orientation of said mounting assembly in said first plane of rotation.

11. A system as in claim 7 wherein the hand-held video game controller is adapted to be gripped by the left and right hands of the user, and wherein said at least one scroll button assembly comprises:
a first scroll button assembly adapted to be coupled to a portion of the video game controller accessible by the user's left hand; and
a second scroll button assembly adapted to be coupled to a portion of the video game controller accessible by the user's right hand.

12. A system as in claim 7 wherein said first means generates a first signal indicative of said rotational position and said second means generates a second signal indicative of said movement, said system further comprising switch means for generating a selection signal indicative of a user-defined relevance of said first signal and said second signal.

13. In a hand-held video game controller, a system for receiving user inputs comprising:
at least one scroll button assembly adapted to be coupled to a region of a hand-held video game controller that is accessible to at least one of a user's index, middle, ring and pinky fingers when the hand-held video game controller is gripped by the user for a gaming operation, each said scroll button assembly including
a housing,
a mounting assembly supported by said housing such that said mounting assembly can be rotated about an axis thereof in a first plane of rotation,
a scrolling wheel coupled to said mounting assembly such that said scrolling wheel can be rotated about an axis thereof in a second plane of rotation that is substantially perpendicular to said first plane of rotation, and
means coupled to said scrolling wheel for detecting a rotational position thereof in said second plane of rotation for any orientation of said mounting assembly in said first plane of rotation,
wherein rotation of said scrolling wheel in said second plane of rotation is adapted for use in scrolling through options presented by a video game.

14. A system as in claim 13 said means comprises an optical assembly mounted on said mounting assembly for rotation in said first plane of rotation.

15. A system as in claim 13 further comprising detent means coupled to said housing and said mounting assembly for maintaining an orientation of said mounting assembly in said first plane of rotation.

16. A system as in claim 13 wherein the hand-held video game controller is adapted to be gripped by the left and right hands of the user, and wherein said at least one scroll button assembly comprises:
a first scroll button assembly adapted to be coupled to a portion of the video game controller accessible by the user's left hand; and
a second scroll button assembly adapted to be coupled to a portion of the video game controller accessible by the user's right hand.

17. A system as in claim 13 wherein said means generates a signal indicative of said rotational position, said system further comprising switch means for generating a selection signal indicative of a user-defined relevance of said signal indicative of said rotational position.
